(19) United States
(12) Patent Application Publication
(10) Pub. No.: US 2025/0274034 A1
(43) Pub. Date: Aug. 28, 2025

(54) ELECTRIC-POWER CONVERSION APPARATUS

(71) Applicant: Mitsubishi Electric Corporation, Tokyo (JP)

(72) Inventors: Fumiya ONO, Tokyo (JP); Nobuhiro KIHARA, Tokyo (JP); Shinsuke IDENOUE, Tokyo (JP)

(73) Assignee: Mitsubishi Electric Corporation, Tokyo (JP)

(21) Appl. No.: 18/858,442

(22) PCT Filed: Oct. 28, 2022
(86) PCT No.: PCT/JP2022/040389

§ 371 Date: Oct. 21, 2024

(30) Foreign Application Priority Data
May 23, 2022 (JP) 2022-083547

(51) Int. Cl. H02M 1/10; B60L 3/00; B60L 7/14; B60L 7/16; B60L 50/61; H02M 1/00; H02M 1/14; H02M 3/158; H02M 7/162; H02M 7/5387

(52) U.S. Cl. CPC H02M 1/10; B60L 3/003; B60L 7/14; B60L 7/16; B60L 50/61; H02M 1/0009; H02M 1/007; H02M 1/14; H02M 3/158; H02M 7/1623; H02M 7/53871; B60L 2240/427; B60L 2240/441; B60L 2240/529; B60L 2240/547

(57) ABSTRACT

An electric-power conversion apparatus including: a first electric-power converter that converts an alternating current generated by a first electric rotating machine coupled to an internal combustion engine, to a direct current; a second electric-power converter that converts a direct current to an alternating current and supplies that alternating current to a second electric rotating machine coupled to drive wheels; a DC power converter that changes a voltage of a battery; a first current sensor that measures a current of the first electric-power converter; a second current sensor that measures a current of the second electric-power converter; a DC-power-converter current sensor that measures a current of the DC power converter; a first sensor power source that supplies electric power to the first current sensor and the DC-power-converter current sensor; and a second sensor power source that supplies electric power to the second current sensor.

### TECHNICAL FIELD

The present application relates to an electric-power conversion apparatus.

### BACKGROUND ART

Hybrid electric vehicles in which an electric-power generator is driven by an internal combustion engine to generate electric power and an electric motor is driven by the generated electric power to thereby give motive power to drive wheels, have been put into practical use. The hybrid electric vehicles each have a battery, so that, at the time the internal combustion engine is stopped, electric power is supplied from the battery to thereby give motive power to the drive wheels of that vehicle. At the time the internal combustion engine is operated, the battery is charged by the electric power of the electric-power generator driven by the internal combustion engine. Further, even during operation of the internal combustion engine, if necessary, the electric power supplied from the battery may be applied together with the electric power generated by the electric-power generator to thereby drive the electric motor more powerfully.

As the electric motor for driving the hybrid electric vehicle, an AC motor represented by a three-phase brushless motor is frequently used. A current generated by the electric-power generator is converted to a direct current, and the direct current serves as a source of DC power to charge the battery. Further, from the source of DC power, an AC current is generated using a DC-to-AC converter (electric-power converter) to thereby drive the AC motor.

With respect to such a hybrid electric vehicle, vector control is applied using the DC-to-AC converter to the primary current of the electric motor so that a target output force for driving is generated. Further, the output power of the internal combustion engine is controlled so that necessary electric power is generated as the output of the DC-to-AC converter. In this regard, a technique has been proposed in which an output current of the electric-power generator and a current supplied from the battery are measured using current sensors to thereby precisely control the supplied current (for example, Patent Document 1).

### CITATION LIST

### Patent Literature

Patent Document 1: Japanese Patent Application Laid-open No. H05-146008

### SUMMARY OF INVENTION

### Technical Problem

In order to more accurately control the output force for driving the hybrid electric vehicle, such a current sensor may be used that measures an output current of the DC-to-AC converter for supplying electric power to the electric motor that drives the drive wheels. As well as the current sensor that measures the output current of the electric-power generator and the current sensor that measures the current supplied from the battery, the current sensor that measures the output current of the DC-to-AC converter for driving the electric motor is an important sensor. In the case where an electric power source is commonly used for operating all of these sensors, if such a sensor power source is lost, the current sensors become all inoperable, making it difficult to perform current control. As the result, the hybrid electric vehicle is difficult to travel. In Patent Document 1, there is no description about a counter-measure against the above problem.

Vehicles are each required to be capable of emergency evacuation traveling when its components have failed partially, even in a performance-limited state. Such a function is referred to as “limp home”. The limp home is a function that causes, in effect, the vehicle to reach the owner's home even under low-speed traveling.

When separate sensor power sources are established each as the sensor power source for each of the various types of current sensors, even if one of these sensor power sources has failed, the sensors other than the sensor corresponding to that sensor power source can continue to be usable because of the other sensor power sources. However, when the sensor power sources are provided fully separately, the number of the sensor power sources increases and the number of supply lines of the sensor power sources increases, resulting in enlargement, weight increase and cost increase of an electric-power conversion apparatus. Reduction in weight, size and cost is required for instruments to be mounted on vehicles. Accordingly, it is required that the improved failure tolerance be optimally balanced with the promoted reduction in weight, size and cost.

The present application has been made to solve the above problem related to the electric-power conversion apparatus, and an object thereof is to provide an electric-power conversion apparatus in which the number of sensor power sources for various types of current sensors are minimized while ensuring a limp home function in response to a failure of the sensor power source.

### Solution to Problem

An electric-power conversion apparatus disclosed in this application comprises:
a first electric-power converter that converts an alternating current that is generated by a first electric rotating machine coupled to an output shaft of an internal combustion engine, to a direct current and outputs said direct current through its DC terminal;
a second electric-power converter that is connected to the DC terminal and that converts a direct current to an alternating current and supplies said alternating current to a second electric rotating machine coupled to a drive wheel;
a DC power converter that is connected between a battery and the DC terminal to cause a voltage change;
a first current sensor that measures a current flowing between the first electric-power converter and the first electric rotating machine;
a second current sensor that measures a current flowing between the second electric-power converter and the second electric rotating machine;
a DC-power-converter current sensor that measures a current flowing between the battery and the DC power converter;
a first sensor power source that supplies electric power to the first current sensor and the DC-power-converter current sensor; and
a second sensor power source that supplies electric power to the second current sensor.

### Advantageous Effects of Invention

In accordance with the electric-power conversion apparatus according to this application, because of the provision of:
the first sensor power supplies electric power to a current sensor for the first electric-power converter that converts an alternating current generated by the first electric rotating machine driven by the internal combustion engine to a direct current, and to a current sensor that measures a current of the DC power converter that steps up the voltage of the battery; and
the second sensor power source that supplies electric power to a current sensor for the second electric-power converter that supplies an alternating current to the second electric rotating machine coupled to the drive wheels,
it is possible to provide an electric-power conversion apparatus in which the number of sensor power sources minimized while ensuring a limp home function in response to a failure of the sensor power source. This makes it possible to decrease the number of sensor power sources in an electric-power conversion apparatus to thereby promote its reduction in size, weight and cost.

### BRIEF DESCRIPTION OF DRAWINGS

FIG. 1 is a configuration diagram of an electric-power conversion apparatus according to Embodiment 1.

FIG. 2 is a hardware configuration diagram of a control device in the electric-power conversion apparatus according to Embodiment 1.

FIG. 3 is a circuit diagram of a first electric-power converter in the electric-power conversion apparatus according to Embodiment 1.

FIG. 4 is a circuit diagram of a second electric-power converter in the electric-power conversion apparatus according to Embodiment 1.

FIG. 5 is a diagram showing an electric-power supply state when sensor power sources in the electric-power conversion apparatus according to Embodiment 1 are all normal.

FIG. 6 is a first diagram showing an electric-power supply state when a first sensor power source in the electric-power conversion apparatus according to Embodiment 1 has failed.

FIG. 7 is a second diagram showing an electric-power supply state when the first sensor power source in the electric-power conversion apparatus according to Embodiment 1 has failed.

FIG. 8 is a diagram showing an electric-power supply state when a second sensor power source in the electric-power conversion apparatus according to Embodiment 1 has failed.

FIG. 9 is a diagram showing an electric-power supply state when a second sensor power source in an electric-power conversion apparatus according to Embodiment 2 has failed.

### DESCRIPTION OF EMBODIMENTS

Hereinafter, embodiments of electric-power conversion apparatuses according to this application will be described with reference to the drawings.

### 1. Embodiment 1

### Configuration of Electric-Power Conversion Apparatus

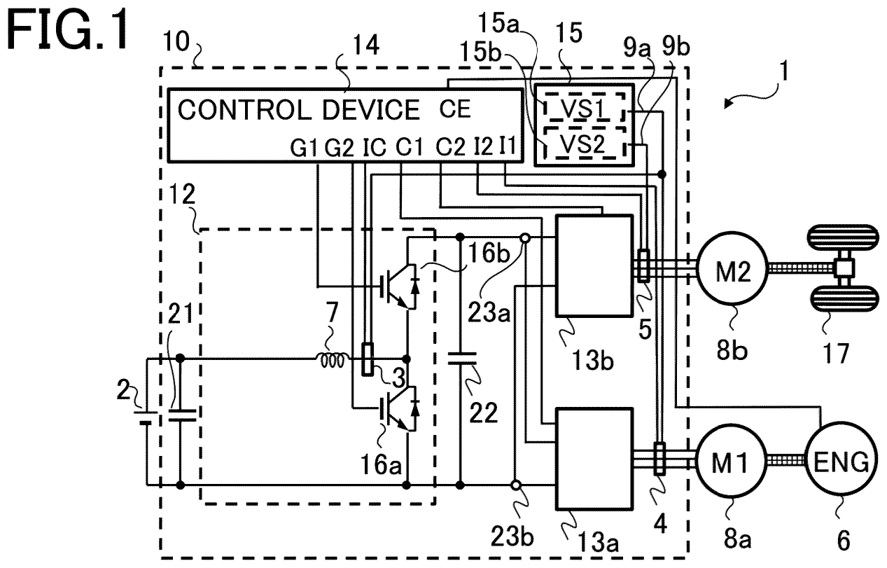

FIG. 1 is a configuration diagram of an electric-power conversion apparatus 10 according to Embodiment 1. The electric-power conversion apparatus 10 is electrically connected to: a battery 2 of a vehicle 1; a first electric rotating machine 8a dynamically coupled to an output shaft of an internal combustion engine 6; and a second electric rotating machine 8b dynamically coupled to drive wheels 17. Here, such dynamic coupling may be direct coupling of main shafts, coupling through a reduction gear and a clutch, or coupling through a rotation transmission mechanism using a belt. In FIG. 1, the internal combustion engine 6 is represented as “ENG”, the first electric rotating machine 8a is represented as “M1”, and the second electric rotating machine 8b is represented as “M2”.

The first electric rotating machine 8a and the second electric rotating machine 8b may each be a three-phase AC electric rotating machine provided with a U-phase winding, a V-phase winding and a W-phase winding. In addition to rotationally driving a load, the first electric rotating machine 8a and the second electric rotating machine 8b may each be able to regenerate electric energy from rotation energy of the load. As each of the first electric rotating machine 8a and the second electric rotating machine 8b, an electric motor having a rotor provided with a permanent magnet, an electric motor having a rotor provided with an electromagnet, a brush-type electric motor, a brushless electric motor, or the like, may be used.

The electric-power conversion apparatus 10 includes a first electric-power converter 13a, a second electric-power converter 13b, a DC power converter 12, a control device 14, a sensor power source 15, a first current sensor 4, a second current sensor 5 and a DC-power-converter current sensor 3. Due to the output power of the internal combustion engine 6 mounted on the vehicle 1, the first electric rotating machine 8a is driven to generate electric power, and alternating currents according to the generated electric power are converted to a direct current by the first electric-power converter 13a, and that direct current is outputted through a positive-side DC terminal 23a and a negative-side DC terminal 23b.

The second electric-power converter 13b to which the direct current is supplied through the positive-side DC terminal 23a and the negative-side DC terminal 23b, converts the direct current to alternating currents to thereby rotate the second electric rotating machine 8b, so that the drive wheels 17 are driven. The DC power converter 12 changes the voltage of the battery 2 mounted on the vehicle 1 and transmits/receives a direct current to/from the positive-side DC terminal 23a and the negative-side DC terminal 23b. When necessary, a current is supplied from the battery 2 to the positive-side DC terminal 23a and the negative-side DC terminal 23b, and when the battery 2 is charged, it receives a current from the positive-side DC terminal 23a and the negative-side DC terminal 23b.

Currents passing through the first electric-power converter 13a, the second electric-power converter 13b and the DC power converter 12 are detected by the first current sensor 4, the second current sensor 5 and the DC-power-converter current sensor 3, respectively. To the first current sensor 4 and the DC-power-converter current sensor 3, electric power is supplied from a first sensor power source 15a through a first sensor power line 9a. To the second current sensor 5, electric power is supplied from a second sensor power source 15b through a second sensor power line 9b. In FIG. 1, the first sensor power source 15a and the second sensor power source 15b are incorporated in the sensor power source 15. However, the first sensor power source 15a and the second sensor power source 15b may be separately placed at different positions.

The control device 14 imports the detection signals of the first current sensor 4 through an input terminal I1, imports the detection signals of the second current sensor 5 through an input terminal I2 and imports the detection signal of the DC-power-converter current sensor 3 through an input terminal IC. The control device 14 controls the second electric-power converter 13b through a control terminal C2. Thus, the control device 14 can control the amount of current for driving the second electric rotating machine 8b, according to a driving force required by the vehicle 1.

The control device 14 controls the first electric-power converter 13a through a control terminal C1. Thus, the control device 14 can control the amount of each current to be generated and supplied by the first electric rotating machine 8a, according to electric power required by the vehicle 1. The control device 14 can adjust the output power of the internal combustion engine 6 by using a signal from a control terminal CE. By adjusting the output power of the internal combustion engine 6 and controlling the rotating speed of the internal combustion engine 6, the control device 14 can control the currents to be generated by the first electric rotating machine 8a.

The DC power converter 12 steps up the voltage of the battery 2 to a voltage across the positive-side DC terminal 23a and the negative-side DC terminal 23b. Information of a current supplied from the battery 2 or a current for charging the battery 2 is transferred as a signal of the DC-power-converter current sensor 3 to the input terminal IC of the control device 14.

### Hardware Configuration of Control Device

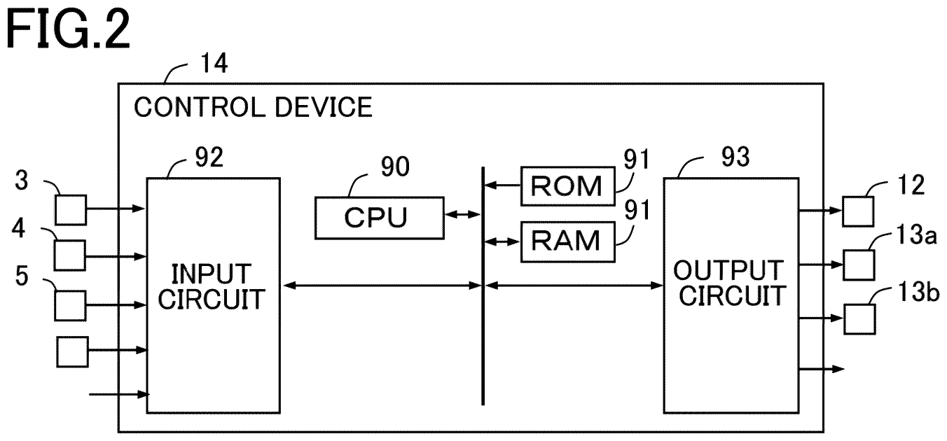

FIG. 2 is a hardware configuration diagram of the control device 14 according to Embodiment 1. The respective functions of the control device 14 are implemented by a processing circuit included in the control device 14. Specifically, as shown in FIG. 2, the control device 14 includes as the processing circuit: an arithmetic processing device 90 (referred to also as a processor) such as a CPU (Central Processing Unit) or the like; storage devices 91 that perform data transactions with the arithmetic processing device 90; interfaces such as an input circuit 92 that inputs external signals to the arithmetic processing device 90, an output circuit 93 that externally outputs signals from the arithmetic processing device 90; and the like.

As the arithmetic processing device 90, there may be included an ASIC (Application Specific Integrated Circuit), an IC (Integrated Circuit), a DSP (Digital Signal Processor), an FPGA (Field Programmable Gate Array), any one of a variety of logic circuits, any one of a variety of signal processing circuits, or the like. Further, multiple arithmetic processing devices 90 of the same type or different types may be included so that the respective parts of processing are executed in a shared manner.

In the control device 14, there are included, as the storage devices 91, a RAM (Random Access Memory) that is configured to allow reading and writing of data by the arithmetic processing device 90, a ROM (Read Only Memory) that is configured to allow reading of data by the arithmetic processing device 90, and the like. The storage device 91 may be incorporated in the arithmetic processing device 90. Input signals, sensors and switches are connected to the input circuit 92, so that the input circuit includes A-D converters for inputting the input signals and signals of the sensors and the switches to the arithmetic processing device 90. Specifically, signals of the first current sensor 4, the second current sensor 5 and the DC-power-converter current sensor 3 are inputted thereto. Electric loads such as a gate drive circuit that drives switching elements to be turned on/off, etc. are connected to the output circuit 93, so that the output circuit includes a drive circuit and the like for outputting control signals from the arithmetic processing device 90 to these electric loads. Specifically, output signals for driving switching elements of the first electric-power converter 13a, the second electric-power converter 13b and the DC power converter 12 are outputted.

The respective functions that the control device 14 includes, are implemented in such a manner that the arithmetic processing device 90 executes software (programs) stored in the storage device 91 such as the ROM or the like, to thereby cooperate with the other hardware in the control device 14, such as the other storage device 91, the input circuit 92, the output circuit 93, etc. Note that the set data of threshold values, determinative values and the like to be used by the control device 14, is stored as a part of the software (programs), in the storage device 91 such as the ROM or the like. Each of the functions of the control device 14 may be established by a software module; however, it may be established by a combination of software and hardware.

### DC Power Converter

The DC power converter 12 in FIG. 1 functions as a voltage conversion device that converts between the voltage of the battery 2 and the voltage across the positive-side DC terminal 23a and the negative-side DC terminal 23b. The DC power converter 12 is referred to also as a DC-DC converter. The DC power converter 12 includes a reactor 7, a positive-side switching element 16b, a negative-side switching element 16a and the DC-power-converter current sensor 3 that detects a reactor current.

The DC power converter 12 is connected to a low-voltage-side smoothing capacitor 21 that smooths a voltage on the low voltage side, and a high-voltage-side smoothing capacitor 22 that smooths a voltage on the high-voltage side. Here, the positive-side switching element 16b and the negative-side switching element 16a are controlled by the control device 14.

The positive-side switching element 16b and the negative-side switching element 16a are connected in series to each other, to thereby constitute a switching circuit in the DC power converter 12. The negative-side switching element 16a may be configured as a plurality of parallelly-connected switching elements. The positive-side switching element 16b may also be configured as a plurality of parallelly-connected switching elements.

The positive-side switching element 16b and the negative-side switching element 16a are subjected to switching control using gate signals from control terminals G1 and G2 of the control device 14, respectively. For example, the positive-side switching element 16b and the negative-side switching element 16a are each composed of an IGBT (Insulated Gate Bipolar Transistor) to which a freewheel diode is connected in reverse parallel. As another example, an FET (Field Effect Transistor) having a parasitic diode connected in reverse parallel thereto may be used as such a switching element. Further, an ordinary bipolar transistor having a diode connected in reverse parallel thereto may be used as such a switching element.

The DC power converter 12 steps up the voltage of the DC electric power outputted by the battery 2 and then supplies that power to the first electric-power converter 13a and the second electric-power converter 13b. Further, in some cases, after the alternating currents generated by the first electric rotating machine 8a are converted by the first electric-power converter 13a to a direct current, the voltage corresponding to that current is stepped down by the DC power converter 12 to thereby charge the battery 2. Namely, the DC power converter 12 functions as a voltage step-up converter or a voltage step-down converter.

### First Electric-Power Converter

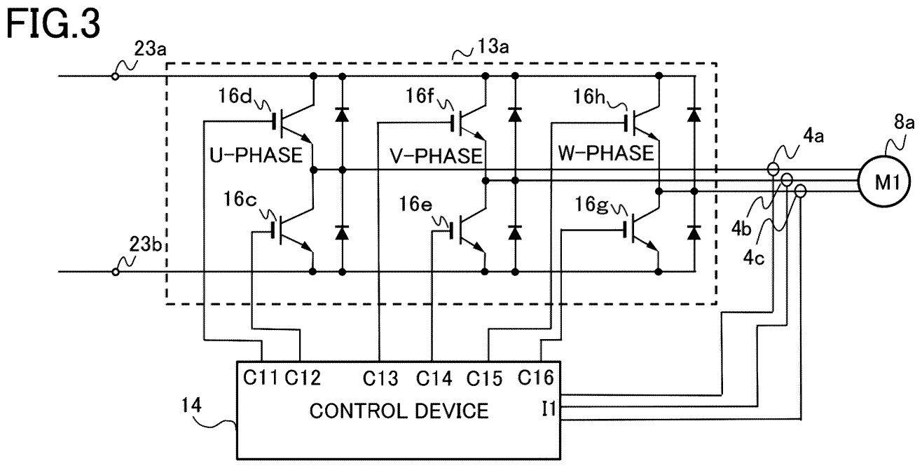

FIG. 3 is a circuit diagram of the first electric-power converter 13a in the electric-power conversion apparatus 10 according to Embodiment 1. The first electric-power converter 13a functions as an AC-to-DC converter that converts three-phase AC currents outputted by the first electric rotating machine 8a to a direct current.

The first electric-power converter 13a has: positive-side switching elements 16d, 16f and 16h for U-phase, V-phase and W-phase that are connected to the positive-side DC terminal 23a; and negative-side switching elements 16c, 16e and 16g for U-phase, V-phase and W-phase that are connected to the negative-side DC terminal 23b. These switching elements are, like the positive-side switching element 16b and the negative-side switching element 16a of the DC power converter 12, each configured with an IGBT or the like and provided with a freewheel diode connected in reverse parallel thereto. The positive-side switching elements for the respective phases are each referred to as an upper arm the and the negative-side switching elements for respective phases are each referred to as a lower arm. The upper arm and the lower arm for each phase are connected in series, so that, through the connection point of them, a three-phase alternating current for U-phase, V-phase or W-phase is delivered.

The connection points for the respective phases are connected to the respective windings of the first electric rotating machine 8a, and the passing currents of the respective phases are detected by first current sensors 4a, 4b and 4c for the respective phases. According to FIG. 1, it has been described that the detection current signals of the first current sensor 4 are imported to the control device 14 through the input terminal I1 thereof. Three input terminals through which the respective detection values of the first current sensor 4a for U-phase, the first current sensor 4b for V-phase and the first current sensor 4c for V-phase are actually imported, are represented by the input terminal I1 as a generic term.

The respective switching elements of the first electric-power converter 13a are controlled by means of control terminals C11 to C16 of the control device 14. In FIG. 1, the control terminals C11 to C16 are represented by the control terminal C1 as a generic term. While monitoring the measurement values of the first current sensor 4 that measures the output currents, the control device 14 controls the respective switching elements and the output power of the internal combustion engine 6 so that the output current of the first electric-power generator 13a gets target value. Namely, the first current sensor 4 is provided for causing the control device 14 to perform feedback control of the output of the first electric-power converter 13a.

The three-phase alternating currents supplied to the first electric-power converter 13a are rectified by the switching elements and converted to the direct current, which is then supplied to the positive-side DC terminal 23a and the negative-side DC terminal 23b. The first electric rotating machine 8a sometimes functions as an electric power generator to supply currents and sometimes functions as an electric motor with currents supplied thereto. The first electric-power converter 13a sometimes functions as an AC-to-DC converter and sometimes functions as a DC-to-AC converter. At a time when the internal combustion engine is stopped, the first electric-power converter 13a converts the direct current from the battery 2, the voltage of which has been changed by the DC power converter 12, to alternating currents to thereby drive the first electric rotating machine 8a, so that the internal combustion engine 6 is activated.

### Second Electric-Power Converter

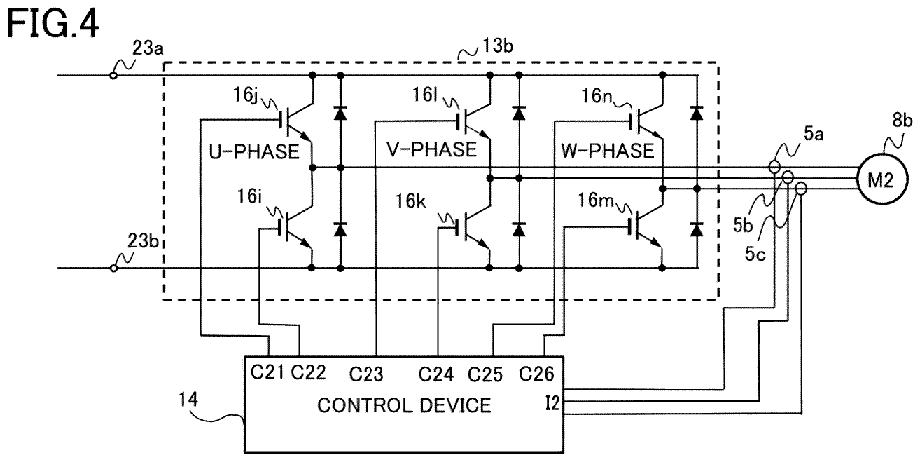

FIG. 4 is a circuit diagram of the second electric-power converter 13b in the electric-power conversion apparatus 10 according to Embodiment 1. The second electric-power converter 13b functions as a DC-to-AC converter that converts the direct current supplied through the positive-side DC terminal 23a and the negative-side DC terminal 23b, to three-phase alternating currents for driving the second electric rotating machine 8b.

The second electric-power converter 13b has: positive-side switching elements 16j, 16l and 16n for U-phase, V-phase and W-phase that are connected to the positive-side DC terminal 23a; and negative-side switching elements 16i, 16k and 16m for U-phase, V-phase and W-phase that are connected to the negative-side DC terminal 23b. These switching elements are, like the positive-side switching element 16b, 16d, 16f, 16h and the negative-side switching elements 16a, 16c, 16e, 16g of the DC power converter 12 and the first electric-power converter 13a, each configured with an IGBT or the like and provided with a freewheel diode connected in reverse parallel thereto. The positive-side switching elements for the respective phases are each referred to as an upper arm and the negative-side switching elements for the respective phases are each referred to as a lower arm. The upper arm and the lower arm for each phase are connected in series, so that, through the connection point of them, a three-phase alternating current for U-phase, V-phase or W-phase is delivered.

The connection points for the respective phases are connected to the respective windings of the second electric rotating machine 8b, and the passing currents of the respective phases are detected by second current sensors 5a, 5b and 5c for the respective phases. According to FIG. 1, it has been described that the detection current signals of the second current sensor 5 are imported to the control device through the input terminal I2 thereof. Three input terminals through which the respective detection values of the second current sensor 5a for U-phase, the second current sensor 5b for V-phase and the second current sensor 5c for W-phase are actually imported, are represented by the input terminal 12 as a generic term.

The respective switching elements of the second electric-power converter 13b are controlled by means of control terminals C21 to C26 of the control device 14. In FIG. 1, the control terminals C21 to C26 are represented by the control terminal C2 as a generic term. While monitoring the measurement values of the second current sensor 5 that measures the output currents, the control device 14 controls the respective switching elements so that the output currents of the second electric-power generator 13b each get a target value. Namely, the second current sensor 5 is provided for causing the control device 14 to perform feedback control of the outputs of the second electric-power converter 13b.

The direct current supplied to the second electric-power converter 13b is duty-controlled by the switching elements to thereby be converted to three-phase alternating currents, which are then supplied to U-phase, V-phase and W-phase coils of the second electric rotating machine 8b. The second electric rotating machine 8b sometimes functions as an electric motor to be driven by currents supplied thereto, and sometimes functions as an electric power generator to supply currents. The second electric-power converter 13b sometimes functions as a DC-to-AC converter and sometimes functions as an AC-to-DC converter. At a time when the vehicle 1 slows down, the second electric rotating machine 8b is driven by the drive wheels 17 to thereby function as an electric power generator, and the second electric-power converter 13b converts the thus-regenerated electric power from AC to DC to thereby charge the battery 2.

### Sensor Power Source

The first current sensor 4, the second current sensor 5 and the DC-power-converter current sensor 3 each receive sensor electric-power supply from the sensor power source 15. Reduction in size, weight and cost is required for on-vehicle instruments. Thus, it is desired even for sensor power sources to commoditize placements of the power sources and wiring lines to the sensors so as to be minimized.

As shown in FIG. 1, in the electric-power conversion apparatus 10 according to Embodiment 1, there are provided three current sensors, that is, the first current sensor 4, the second current sensor 5 and the DC-power-converter current sensor 3. As electric power sources for operating these sensors, two power sources, that is, the first sensor power source 15a and the second sensor power source 15b are set, and as wiring lines for supplying electric power, two lines, that is, the first sensor power line 9a and the second sensor power line 9b are used, so that the reduction in size, weight and cost is achieved while establishing improved failure tolerance. Note that these multiple elements of sensors may be of the same type; however, elements of sensors of different types may instead be used.

Flow of Current when Sensor Power Sources Are Normal

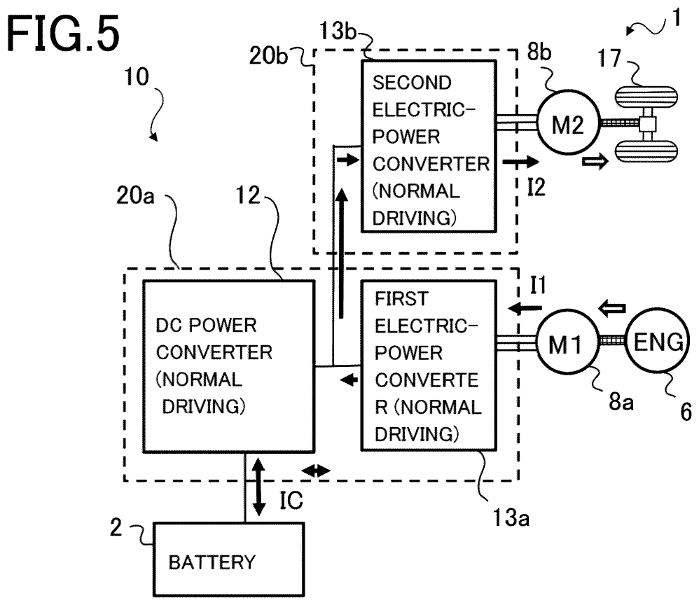

FIG. 5 is a diagram showing an electric-power supply state when the sensor power sources in the electric-power conversion apparatus according to Embodiment 1 are all normal. A transmitted motive force applied to the first electric rotating machine 8a driven by the internal combustion engine 6 is indicated by a white arrow. The alternating currents generated by the first electric rotating machine 8a are converted to a direct current by the first electric-power converter 13a.

Then, the thus-converted direct current is converted to alternating currents by the second electric-power converter 13b to thereby drive the second electric rotating machine 8b. This series of current flow is indicated by arrows. A transmitted motive force applied to the drive wheels 17 driven by the second electric rotating machine 8b is indicated by another white arrow. In FIG. 5, currents to be detected by the first current sensor 4 are indicated by “I1”, currents to be detected by the second current sensor 5 are indicated by “I2”, and a current to be detected by the DC-power-converter current sensor 3 is indicated by “IC”.

The battery 2 causes direct-current change with the DC power converter 12, and the DC power converter 12 causes direct-current change with the first electric-power converter 13a and the second electric-power converter 13b. In FIG. 5, the group of converters subject to feedback control by use of the current sensors operated by the first sensor power source 15a, is indicated by a region 20a. The converter subject to feedback control by use of the current sensor operated by the second sensor power source 15b, is indicated by a region 20b.

Flow of Current when First Sensor Power Source Has Failed

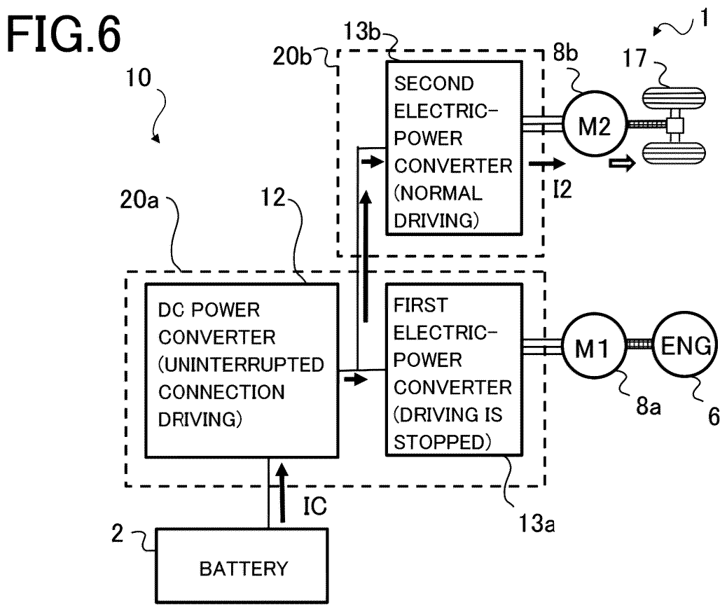

FIG. 6 is a first diagram showing an electric-power supply state when the first sensor power source 15a in the electric-power conversion apparatus 10 according to Embodiment 1 has failed. When the first sensor power source 15a or the first sensor power line 9a becomes defective, the first current sensor 4 and the DC-power-converter current sensor 3 lose electric power for operating these sensors, and thus cannot detect the currents.

On this occasion, the control device 14 cannot perform feedback control with respect to the first electric-power converter 13a and the DC power converter 12. This means that the first electric-power converter 13a cannot be driven normally and the DC power converter 12 cannot perform voltage step-up operation and voltage step-down operation.

The DC power converter 12 becomes unable to use the DC-power-converter current sensor 3 and is thus hard to perform voltage step-up operation and voltage step-down operation. In this case, using the gate signals outputted from the control terminals G1, G2, the control device 14 continuously turns on the positive-side switching element 16b and continuously turns off the negative-side switching element 16a, so that the DC terminal can be connected to the battery 2 without interruption.

The driving state of the DC power converter at this time is called “directly driving”. The directly driving makes it possible to supply a current from the battery 2 to the second electric-power converter 13b. The flow of current at that time is indicated by an arrow. In this case, when the second sensor power source 15b is normal, the output currents of the second electric-power converter 13b are detectable by the second current sensor. Accordingly, it is possible to perform current-feedback control for the second electric rotating machine 8b.

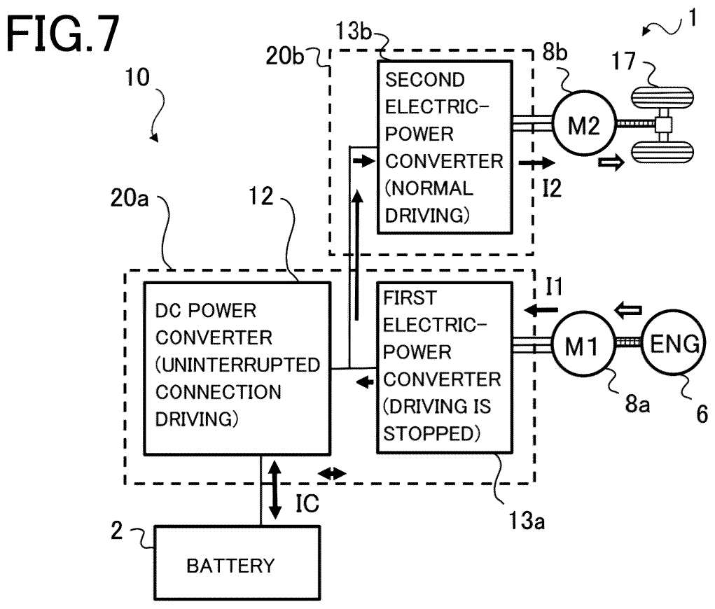

FIG. 7 is a second diagram showing an electric-power supply state when the first sensor power source in the electric-power conversion apparatus according to Embodiment 1 has failed. The first electric-power converter 13a cannot be driven normally, so that its driving is stopped. However, the first electric-power converter 13a, even during stoppage of its driving, can function as a three-phase full-wave rectifier circuit because of the freewheel diodes connected in reverse parallel to the respective switching elements.

In this situation, it is allowed to increase the rotating speed of the internal combustion engine 6 by using a command from the control device 14. This makes it possible to control an induction voltage generated by the first electric rotating machine 8a to be larger than the voltage of the battery 2.

Accordingly, it is possible to supply the currents generated by the first electric rotating machine 8a driven by the internal combustion engine 6, to the second electric-power generator 13b and the battery 2, through three-phase full-wave rectification. In FIG. 7, the flow of current at this time is indicated by an arrow.

Assuming for example that the voltage of the battery 2 is 14.7 V, a rotating speed of the internal combustion engine 6 at which the induction voltage of the first electric rotating machine 8a exceeds the voltage of the battery may be measured and defined beforehand. The control device 14 may control the internal combustion engine 6 to have the thus-defined rotating speed or more. Further, a battery voltage sensor that detects the voltage of the battery 2 may be provided. The control device 14 may control the internal combustion engine 6 to have a rotating speed at which the induction voltage that exceeds the detection value of the battery voltage sensor is generated.

Furthermore, with the provision of a first electric-rotating-machine voltage sensor that detects the output voltage of the first electric rotating machine 8a, the induction voltage generated by the first electric rotating machine 8a may be detected. The control device 14, when detecting an abnormality of the first sensor power source 15a, adjusts the rotating speed of the internal combustion engine so that the induction voltage detected by the first electric-rotating-machine voltage sensor is larger than the battery voltage detected by the battery voltage sensor. This makes it more certain that the currents generated by the first electric rotating machine 8a driven by the internal combustion engine 6 will be supplied through three-phase full-wave rectification to the second electric-power converter 13b and the battery 2.

Even when the first sensor power source 15a has failed, the second electric-power converter 13b can be driven normally. Since the second current sensor 5 is operated by receiving sensor electric-power supply from the second sensor power source 15b, the control device 14 can put the second electric-power converter 13b under feedback control. Using the current that is supplied from the battery 2 when the DC power converter 12 is put under directly driving, and the current that is generated by the first electric-power converter 13a and due to supplied three-phase full waves, the second electric-power converter 13b can accurately drive the second electric rotating machine 8b.

In this manner, even when the first sensor power source 15a has failed, the vehicle 1 can control the second electric rotating machine 8b. When the DC power converter 12 is controlled to be directly connected, the voltage at the DC terminal decreases, so that the currents provided by the second electric-power converter 13b for driving the second electric rotating machine 8b are restricted. However, the vehicle 1 is allowed to travel by driving the drive wheels 17, so that the limp home function can be ensured. Furthermore, when the rotating speed of the internal combustion engine 6 is increased, it becomes possible to charge the battery 2 by using the currents generated by the first electric rotating machine 8a. This makes it possible to extend the travelable time and the travelable distance of the vehicle 1 corresponding to the amount of charge of the battery 2 at that time.

Flow of Current when Second Sensor Power Source Has Failed

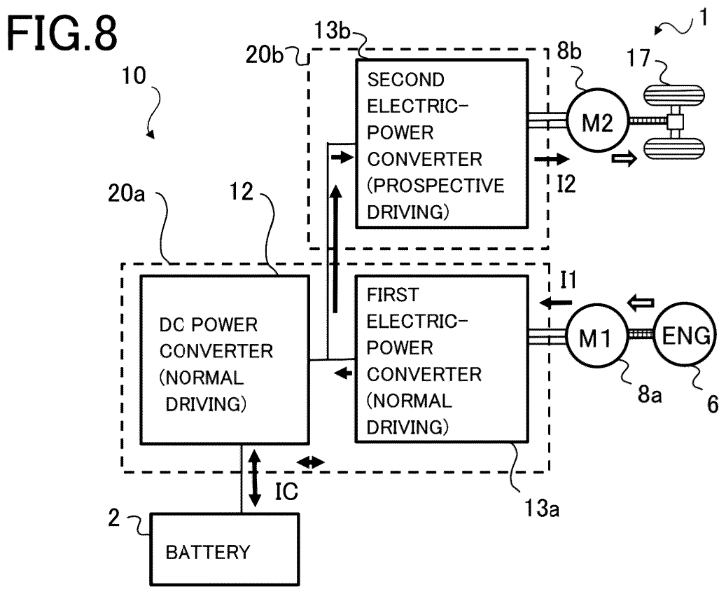

FIG. 8 is a diagram showing an electric-power supply state when the second sensor power source 15b in the electric-power conversion apparatus 10 according to Embodiment 1 has failed. When the second sensor power source 15b or the second sensor power line 9b becomes defective, the second current sensor 5 loses electric power for operating that sensor, and thus cannot detect the currents.

On this occasion, the control device 14 cannot perform current-feedback control with respect to the second electric-power converter 13b. However, the control device 14 can prospectively drive the second electric rotating machine 8b by applying PWM (Pulse Width Modulation) control to the switching elements of the second electric-power converter 13b so that currents required for driving the second electric rotating machine 8b each have a pulse width that is predetermined corresponding to these currents. Accordingly, even though incapable of performing highly accurate feedback control using the second current sensor 5 on the output currents, it is possible to ensure the limp home function.

Since there are provided the first sensor power source 15a that supplies electric power to the first current sensor 4 for the first electric-power converter 13a and to the DC-power-converter current sensor 3, and the second sensor power source 15b that supplies electric power to the second current sensor 5 for the second electric-power converter 13b, it is possible to provide such an electric-power conversion apparatus 10 in which the number of sensor power sources are minimized while ensuring the limp home function in response to a failure of the sensor power source. This makes it possible to decrease the number of sensor power sources in the electric-power conversion apparatus 10 to thereby promote its reduction in size, weight and cost.

### 2. Embodiment 2

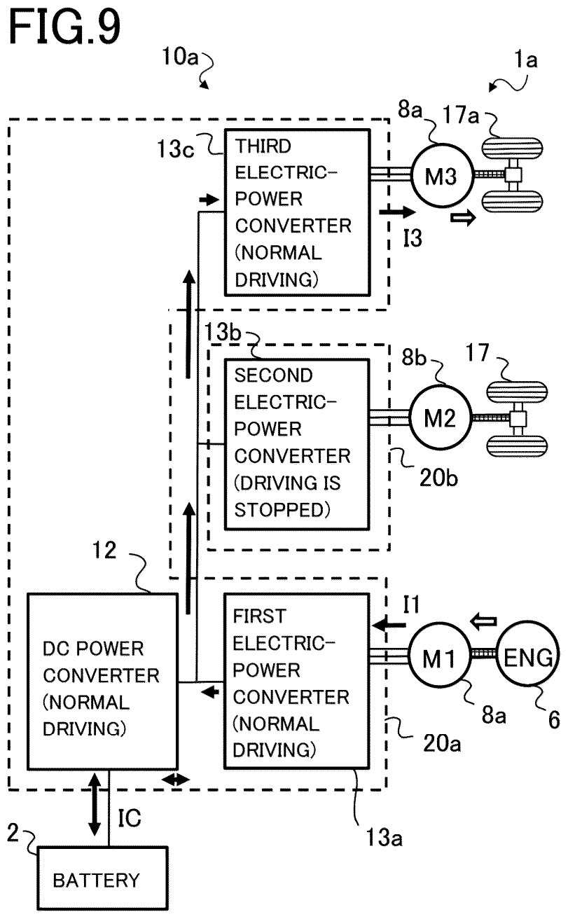

FIG. 9 is a diagram showing an electric-power supply state when a second sensor power source 15b in an electric-power conversion apparatus 10a according to Embodiment 2 has failed. The configuration of the electric-power conversion apparatus 10a according to Embodiment 2 differs from the configuration of the electric-power conversion apparatus 10 according to Embodiment 1, in that a third electric-power converter 13c is added. A control device 14a controls the switching elements of the third electric-power converter 13c, additionally to those of the first electric-power converter 13a and the DC power converter 12 (the control device 14a is not illustrated).

A vehicle 1a on which the electric-power conversion apparatus 10a according to Embodiment 2 is mounted, includes a third electric rotating machine 8c. In FIG. 1, the third electric rotating machine 8c is represented as “M3”. The third electric rotating machine 8c is used as a rear electric rotating machine for traveling that drives rear wheels 17a. A target to be driven by the third electric rotating machine 8c may instead be the drive wheels 17. The third electric rotating machine 8c is driven by currents supplied by the third electric-power converter 13c. Other than the above, the electric-power conversion apparatus 10a according to Embodiment 2 is the same as the electric-power conversion apparatus 10 according to Embodiment 1.

Flow of Current when Second Sensor Power Source Has Failed

When the second sensor power source 15b or the second sensor power line 9b becomes defective, the second current sensor 5 loses electric power for operating that sensor, and thus cannot detect the currents. On this occasion, the control device 14a cannot perform current-feedback control with respect to the second electric-power converter 13b.

Even in this case, the third electric-power converter 13c can be driven normally. A current resulting from voltage-conversion of the electric power of the battery 2 by the DC power converter 12 and supplied to the DC terminal, and a current based on the electric power generated by the first electric rotating machine 8a and supplied to the DC terminal by the first electric-power converter, can be supplied to the third electric-power converter 13c. This makes it possible that the control device 14a controls the third electric-power converter 13c to supply currents to the third electric rotating machine 8c, to thereby drive the rear wheels 17a to achieve traveling.

In this case, the second electric-power converter 13b stops being driven. The second electric rotating machine 8b is rotated in a manner dragged by the drive wheels 17. Since the second electric rotating machine 8b is so rotated, an inverse electromotive force is generated. The second electric rotating machine 8b functions as an electric-power generator, so that, in the second electric-power converter 13b during stoppage of driving, a direct current is generated due to rectifying action by the freewheel diodes connected in reverse parallel to the switching elements of that converter. This current interferes in controlling the third electric-power converter 13c. As the rotating speed of the drive wheels 17 increases, the induction voltage of the second electric rotating machine 8b increases. Thus, in order to suppress the induction voltage of the second electric rotating machine 8b, it is not allowed to increase the traveling speed at the time of limp home beyond a given speed.

In this case, however, when the control device 14a causes the DC power converter 12 to perform voltage step-up operation, it is possible to reduce disturbance due to the induction voltage of the second electric rotating machine 8b. Accordingly, for the DC power converter 12, a reasonable step-up voltage that is higher than its normal-time step-up voltage may be predetermined. Then, the control device 14a causes the DC power converter 12 to perform voltage step-up operation up to the predetermined step-up voltage. Instead, the DC power converter 12 may step up the voltage up to the rated maximum voltage thereof.

In order to drive the third electric rotating machine 8c by the third electric-power converter 13c, a third current sensor that detects the output currents of the third electric-power converter 13c may be provided to thereby apply highly accurate current-feedback control. In this case, sensor electric-power supply for the third current sensor may be received from the first sensor power source 15a. This makes it possible for the control device 14a to accurately perform current-feedback control of the third electric-power converter 13c even when the second sensor power source 15b or the second sensor power line 9b becomes defective. In FIG. 9, currents to be detected by the third current sensor are indicated by “I3”.

In Embodiment 2, when the first sensor power source 15a or the first sensor power line 9a becomes defective, the control device 14a stops driving of the first electric-power converter 13a and controls the DC power source 12 to be directly connected. In this case, it is possible to take action and to ensure the limp home function as has been described in Embodiment 1, so that further description will be omitted.

As described above, in accordance with the electric-power conversion apparatus 10a according to Embodiment 2, it is possible to provide an electric-power conversion apparatus 10a in which the number of sensor power sources are minimized while ensuring a satisfactory limp home function in response to a failure of the sensor power source. This makes it possible to decrease the number of sensor power sources in the electric-power conversion apparatus 10a to thereby promote its reduction in size, weight and cost.

In this application, a variety of exemplary embodiments and examples are described; however, every characteristic, configuration or function that is described in one or more embodiments, is not limited to being applied to a specific embodiment, and may be applied alone or in any of various combinations thereof to another embodiment. Accordingly, an infinite number of modified examples that are not exemplified here are supposed within the technical scope disclosed in the description of this application. For example, such cases shall be included where at least one configuration element is modified; where at least one configuration element is added or omitted; and furthermore, where at least one configuration element is extracted and combined with a configuration element of another embodiment.

Various embodiments disclosed above are summarized in the following appendices.

### Appendix 1

An electric-power conversion apparatus comprising:
a first electric-power converter that converts an alternating current that is generated by a first electric rotating machine coupled to an output shaft of an internal combustion engine, to a direct current and outputs said direct current through its DC terminal;
a second electric-power converter that is connected to the DC terminal and that converts a direct current to an alternating current and supplies said alternating current to a second electric rotating machine coupled to a drive wheel;
a DC power converter that is connected between a battery and the DC terminal to cause a voltage change;
a first current sensor that measures a current flowing between the first electric-power converter and the first electric rotating machine;
a second current sensor that measures a current flowing between the second electric-power converter and the second electric rotating machine;
a DC-power-converter current sensor that measures a current flowing between the battery and the DC power converter;
a first sensor power source that supplies electric power to the first current sensor and the DC-power-converter current sensor; and
a second sensor power source that supplies electric power to the second current sensor.

### Appendix 2

The electric-power conversion apparatus as set forth in claim 1, which comprises a control device that controls the DC power converter;
wherein the DC power converter has a positive-side switching element, a negative-side switching element and a reactor; and
wherein the control device, when detecting an abnormality of the first sensor power source, puts the DC power converter under directly driving.

### Appendix 3

The electric-power conversion apparatus as set forth in claim 2, wherein the control device, when detecting an abnormality of the first sensor power source, turns on the positive-side switching element and turns off the negative-side switching element.

### Appendix 4

The electric-power conversion apparatus as set forth in claim 2 or 3, further comprising a battery voltage sensor that detects a voltage of the battery, and a first-electric-rotating-machine voltage sensor that detects an output voltage of the first electric rotating machine;
wherein the control device, when detecting an abnormality of the first sensor power source, adjusts a rotating speed of the internal combustion engine so that an induction voltage detected by the first-electric-rotating-machine voltage sensor is larger than a battery voltage detected by the battery voltage sensor.

### Appendix 5

The electric-power conversion apparatus as set forth in any one of claims 2 to 4, wherein,
when the first sensor power source and the second sensor power source are normal, the control device controls the first electric-power converter on a basis of a current value detected by the first current sensor, controls the second electric-power converter on a basis of a current value detected by the second current sensor, and controls the DC power converter on a basis of a current value detected by the DC-power-converter current sensor; and
when detecting an abnormality of the second sensor power source, the control device controls the second electric-power converter without using a current value detected by the second current sensor.

### Appendix 6

The electric-power conversion apparatus as set forth in any one of claims 2 to 5, further comprising a third electric-power converter that is connected to the DC terminal and that converts a direct current to an alternating current and supplies said alternating current to a third electric rotating machine coupled to a drive wheel,
wherein, when detecting an abnormality of the second sensor power source, the control device stops driving of the second electric-power converter and controls the first electric-power converter, the third electric-power converter and the DC power converter. cl Appendix 7

The electric-power conversion apparatus as set forth in claim 6, further comprising a third current sensor that measures a current flowing between the third electric-power converter and the third electric rotating machine,
wherein the third current sensor receives electric-power supply from the first sensor power source.

### Appendix 8

The electric-power conversion apparatus as set forth in claim 6 or 7, wherein, when detecting an abnormality of the second sensor power source, the control device steps up, using the DC power converter, a voltage at the DC terminal to a predetermined voltage that is higher than a normal voltage at a time when the second sensor power source is normal.

### Appendix 9

The electric-power conversion apparatus as set forth in claim 8, wherein, when detecting an abnormality of the second sensor power source, the control device steps up, using the DC power converter, the voltage at the DC terminal to a rated maximum voltage.

### Appendix 10

The electric-power conversion apparatus as set forth in any one of claims 1 to 9,
wherein, when the internal combustion engine is to be activated, the first electric-power converter drives the first electric rotating machine while converting the direct current provided through the DC terminal to an alternating current; and
wherein, when the second electric rotating machine regenerates electric power, the second electric-power converter converts an alternating current generated by the second electric rotating machine to a direct current and outputs said direct current to the DC terminal.

### DESCRIPTION OF REFERENCE NUMERALS

2: battery, 3: DC-power-converter current sensor, 4: first current sensor, 5: second current sensor, 6: internal combustion engine, 8a: first electric rotating machine, 8b: second electric rotating machine, 8c: third electric rotating machine, 10, 10a: electric-power conversion apparatus, 12: DC power converter, 13a: first electric-power converter, 13b: second electric-power converter, 13c: third electric-power converter, 14, 14a: control device, 15a: first sensor power source, 15b: second sensor power source, 16a: negative-side switching element, 16b: positive-side switching element, 17: drive wheels, 17a: rear wheels.

1. An electric-power conversion apparatus comprising:
a first electric-power converter that converts an alternating current that is generated by a first electric rotating machine coupled to an output shaft of an internal combustion engine, to a direct current and outputs said direct current through its DC terminal;
a second electric-power converter that is connected to the DC terminal and that converts a direct current to an alternating current and supplies said alternating current to a second electric rotating machine coupled to a drive wheel;
a DC power converter that is connected between a battery and the DC terminal to cause a voltage change;
a first current sensor that measures a current flowing between the first electric-power converter and the first electric rotating machine;
a second current sensor that measures a current flowing between the second electric-power converter and the second electric rotating machine;
a DC-power-converter current sensor that measures a current flowing between the battery and the DC power converter;
a first sensor power source that supplies electric power to the first current sensor and the DC-power-converter current sensor; and
a second sensor power source that supplies electric power to the second current sensor.

2. The electric-power conversion apparatus as set forth in claim 1, which comprises a controller that controls the DC power converter;
wherein the DC power converter has a positive-side switching element, a negative-side switching element and a reactor; and
wherein the controller, when detecting an abnormality of the first sensor power source, puts the DC power converter under directly driving.

3. The electric-power conversion apparatus as set forth in claim 2, wherein the controller, when detecting an abnormality of the first sensor power source, turns on the positive-side switching element and turns off the negative-side switching element.

4. The electric-power conversion apparatus as set forth in claim 2, further comprising a battery voltage sensor that detects a voltage of the battery, and a first-electric-rotating-machine voltage sensor that detects an output voltage of the first electric rotating machine;
wherein the controller, when detecting an abnormality of the first sensor power source, adjusts a rotating speed of the internal combustion engine so that an induction voltage detected by the first-electric-rotating-machine voltage sensor is larger than a battery voltage detected by the battery voltage sensor.

5. The electric-power conversion apparatus as set forth in claim 2, wherein,
when the first sensor power source and the second sensor power source are normal, the controller controls the first electric-power converter on a basis of a current value detected by the first current sensor, controls the second electric-power converter on a basis of a current value detected by the second current sensor, and controls the DC power converter on a basis of a current value detected by the DC-power-converter current sensor; and
when detecting an abnormality of the second sensor power source, the controller controls the second electric-power converter without using a current value detected by the second current sensor.

6. The electric-power conversion apparatus as set forth in claim 2, further comprising a third electric-power converter that is connected to the DC terminal and that converts a direct current to an alternating current and supplies said alternating current to a third electric rotating machine coupled to a drive wheel,
wherein, when detecting an abnormality of the second sensor power source, the controller stops driving of the second electric-power converter and controls the first electric-power converter, the third electric-power converter and the DC power converter.

7. The electric-power conversion apparatus as set forth in claim 6, further comprising a third current sensor that measures a current flowing between the third electric-power converter and the third electric rotating machine,
wherein the third current sensor receives electric-power supply from the first sensor power source.

8. The electric-power conversion apparatus as set forth in claim 6, wherein, when detecting an abnormality of the second sensor power source, the controller steps up, using the DC power converter, a voltage at the DC terminal to a predetermined voltage that is higher than a normal voltage at a time when the second sensor power source is normal.

9. The electric-power conversion apparatus as set forth in claim 8, wherein, when detecting an abnormality of the second sensor power source, the controller steps up, using the DC power converter, the voltage at the DC terminal to a rated maximum voltage.

10. The electric-power conversion apparatus as set forth in claim 1,
wherein, when the internal combustion engine is to be activated, the first electric-power converter drives the first electric rotating machine while converting the direct current provided through the DC terminal to an alternating current; and
wherein, when the second electric rotating machine regenerates electric power, the second electric-power converter converts an alternating current generated by the second electric rotating machine to a direct current and outputs said direct current to the DC terminal.
